(19) United States
(12) Patent Application Publication
(10) Pub. No.: US 2019/0340797 A1
(43) Pub. Date: Nov. 7, 2019

(54) SYSTEM AND METHOD FOR A DYNAMIC MAP DISPLAY WITH ACTUAL IMAGES

(71) Applicant: VISTEON GLOBAL TECHNOLOGIES, INC., Van Buren Township, MI (US)

(72) Inventors: THORSTEN WILMER, BRUCHSAL (DE); WAHEED AHMED, WOERTH AM RHEIN (DE); ALEXANDRA SCHAEFER, KARLSRUHE (DE)

(21) Appl. No.: 15/970,371

(22) Filed: May 3, 2018

(51) Int. Cl. G06T 11/60; B60R 1/00

(52) U.S. Cl. CPC G06T 11/60; G01C 21/3667; B60R 1/00

(57) ABSTRACT

A dynamic map display presents a dynamic image on a display screen of a vehicle. The dynamic map display includes a camera aimed at and above the horizon in front of the vehicle to capture a background image, which is transmitted to a controller via a first communications channel. A map generator within the controller generates a map image showing navigational directions. The controller also includes an image generator combining the background image with the map image as the dynamic image, which is transmitted to the display screen via a second communications channel. The background image and the map image are each complementary shaped to fill the display screen in any one of several different views and with the background image and the map image having different shapes and/or sizes. A method for generating a dynamic image is also disclosed.

### BACKGROUND

Dynamic map displays, such as the type used for vehicular navigation systems, commonly provide different viewing perspectives. Viewing perspectives representing a first-person or a perspective view including a background area outside of the map image of the region of terrain being mapped. Such background areas are generally filled with a solid color or with a static image, which may represent the sky area above the map image.

### SUMMARY

A dynamic map display presenting a dynamic image on a display screen of a vehicle is disclosed. The dynamic map display includes a camera having a field of view and capturing a background image and transmitting the background image to a controller via a first communications channel.

The controller includes a GPS receiver determining a location of the vehicle in physical space and a map generator generating a map image. The controller also includes an image generator combining the background image with the map image as the dynamic image. The dynamic image is then transmitted from the controller to the display screen via a second communications channel.

A method for generating a dynamic image by a dynamic map display is also disclosed. The method includes observing a background image by a camera; and transmitting the background image to a controller via a first communications channel. The method also includes the steps of determining a location of the vehicle in physical space by a GPS receiver; generating a map image by a map generator; and combining the background image with the map image as a dynamic image. The method proceeds with the steps of transmitting the dynamic image to the display screen via a second communications channel; and presenting the dynamic image on the display screen.

### BRIEF DESCRIPTION OF THE DRAWINGS

Further details, features and advantages of designs of the invention result from the following description of embodiment examples in reference to the associated drawings.

FIG. 1 is a schematic diagram of a dynamic map display in accordance with the present disclosure;

FIG. 2 is a block diagram of a controller of the dynamic map display;

FIG. 3 is an example of a dynamic image having a tilted top view;

FIG. 4 is an example of a dynamic image having a perspective view from above and behind a vehicle;

FIG. 5 is an example of a dynamic image having a first-person perspective; and

FIG. 6 is a flow chart of steps in a method for generating a dynamic image.

### DETAILED DESCRIPTION

Recurring features are marked with identical reference numerals in the figures, in which a dynamic map display 10 presenting a dynamic image 20 on a display screen 22 of a vehicle 12 is disclosed. The display screen 22 may be an LCD or OLED or similar display, and may be part of an infotainment or navigation system mounted on or in the dashboard of the vehicle 12. Two or more display screens 22 may be configured to display the dynamic image 20. For example, multiple passengers within a car, truck, bus, train, or aircraft may have an infotainment display screen 22 mounted nearby, and which is capable of displaying the dynamic image 20. Such infotainment displays may be mounted in the headrest or seatback of a seat in front of another seat within the vehicle. The display screen 22 may also take other forms such as, for example, a head-up display (HUD).

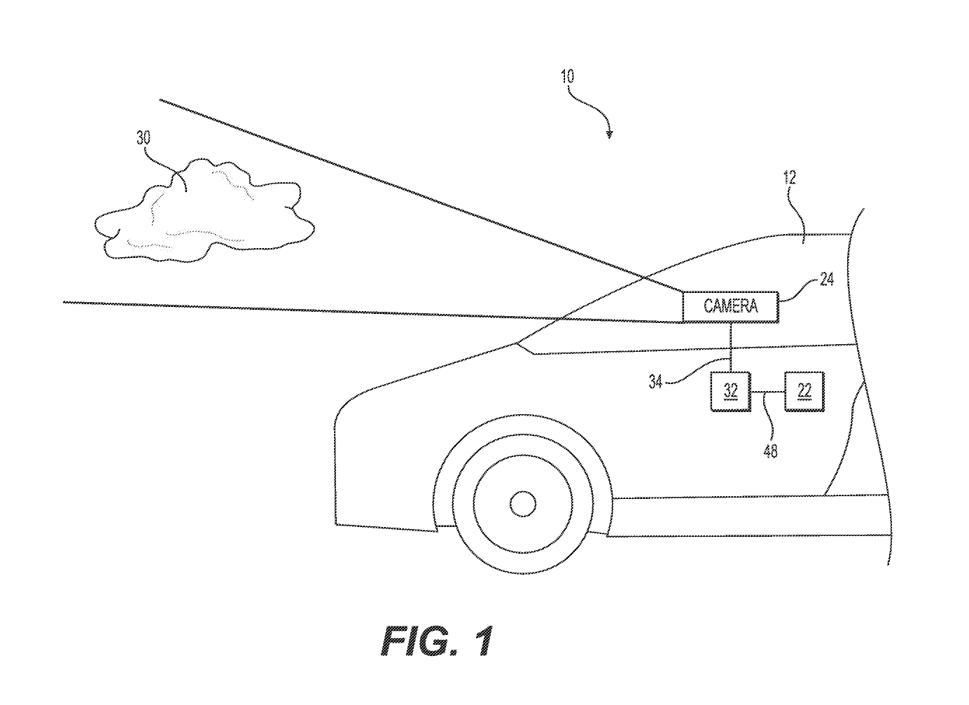

As shown in FIG. 1, the dynamic map display 10 includes a camera 24 having a field of view 26 and capturing a background image 28 including one or more objects 30, such as the sky, clouds, overhead lights, tall buildings, etc. The field of view 26 is aimed at and above the horizon in front of the vehicle 12 so the background image 28 includes the sky and other terrain or objects 30 above the level of the horizon.

The camera 24 is in a communication with a controller 32 via a first communications channel 34 to transmit the background image 28 thereto. The first communications channel 34 may be wired or wireless or a combination thereof and may transmit the background image 28 via a digital or analog signal.

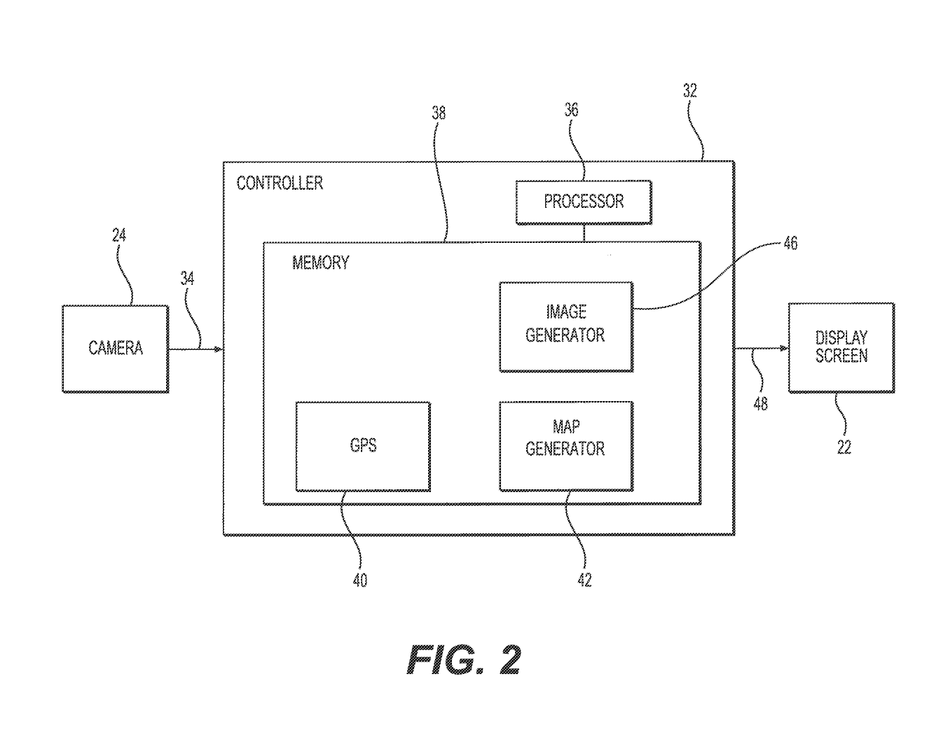

As best shown in FIG. 2, the controller 32 includes a processor 36 and a computer readable non-transitory memory 38 storing instructions for execution by the processor 36 to allow the controller to perform a number of different functions. The controller 32 includes a GPS receiver 40 for determining a location of the vehicle in physical space. The GPS receiver 40 may include a combination of hardware and software in the form of the instructions within the memory 38.

The controller 32 also includes a map generator 42 to generate a map image 44 showing navigational directions 45, and which may be realized in software instructions stored in the memory 38 for execution by the processor 36. The controller 32 also includes an image generator 46 for combining the background image 28 with the map image 44 as the dynamic image 20. The image generator 46 may also take the form of software instructions stored in the memory 38 for execution by the processor 36. As shown in FIG. 1, the controller 32 transmits the dynamic image 20 to the display screen 22 via a second communications channel 48 extending therebetween. The second communications channel 48 may be wired or wireless or a combination thereof and may transmit the dynamic image 20 by an analog or digital signal.

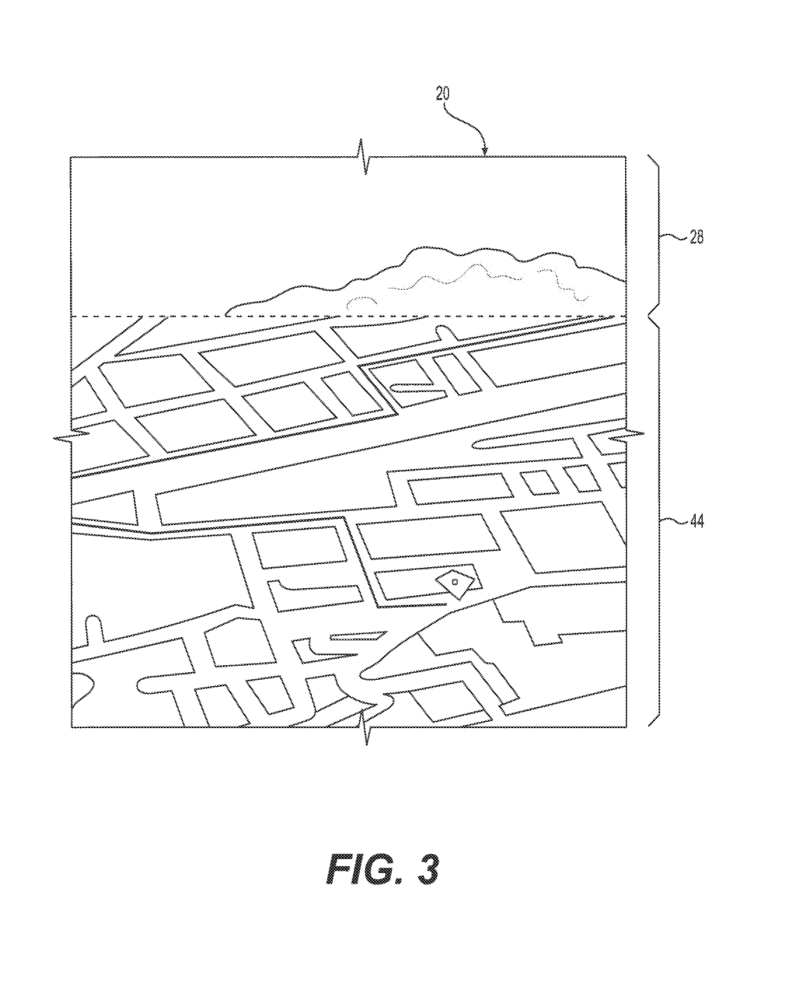

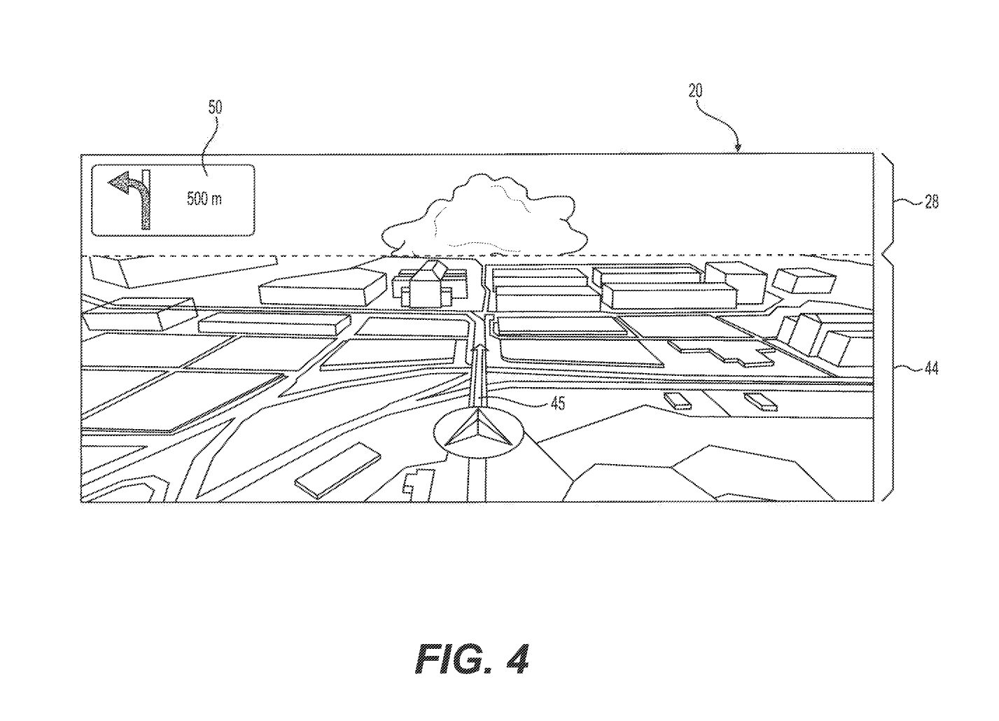

According to an aspect, the background image 28 and the map image 44 are each complementary shaped to fill the display screen 22. For example, as shown in FIGS. 3, and 4, each of the background image 28 and the map image 44 are rectangular. Other complementary shapes may be used such as more complex cut-outs which may be dynamically determined, for example, where a portion of the display screen 22 representing one or more roads in front of the vehicle may be part of the map image 44, and other regions above and beside the road may be filled with the background image 28.

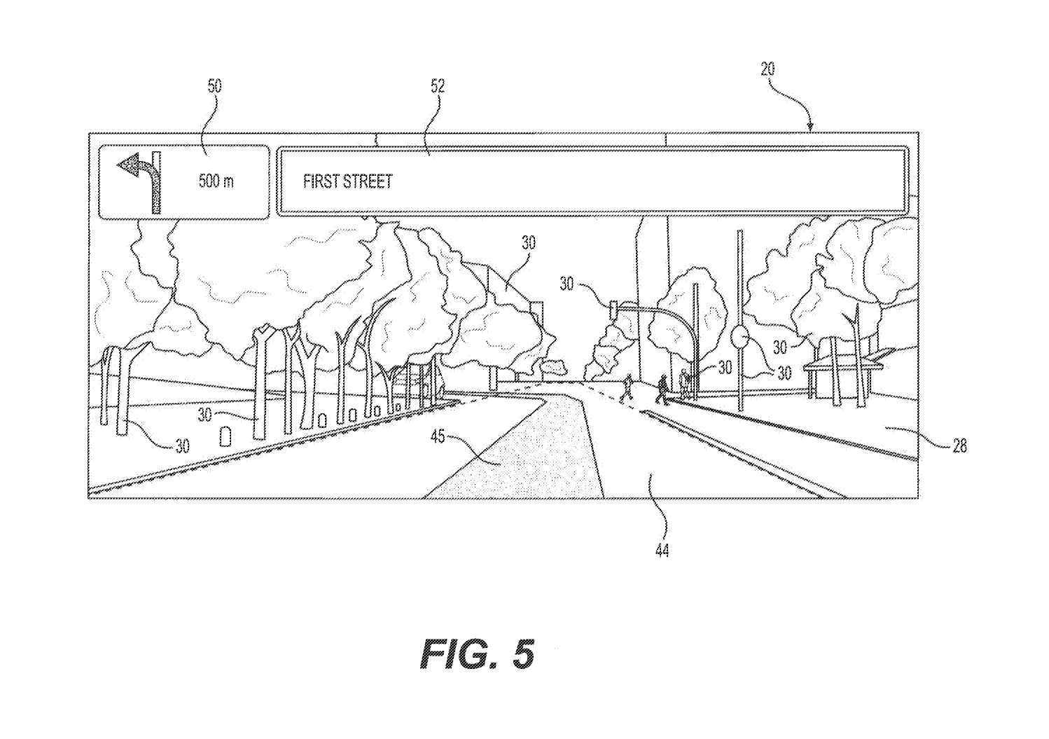

As shown in FIG. 3, the map image 44 may be formed as a tilted top view, which is also known as a 2.5D image, and which may be generated by simple scaling of a 2-dimensional image. As shown in FIG. 4, the map image 44 may have a perspective view from above and behind the vehicle. Such a map image 44 may be formed by overlying 3-dimensional objects, such as buildings, on a 2.5D image such as the one shown in FIG. 3. Alternatively, the map image 44 may have a first-person perspective, which is also called a first-person-view (FPV). An example of a FPV map image 44 is shown in FIG. 5. Such an FPV map image 44 is preferably limited to only the area of road ahead and visible to the vehicle 12. The remaining area outside of the map image 44 may then be filled with filled with the background image 28 to create a realistic scene, and which includes objects 30 such as, for example, trees, buildings, pedestrians, traffic signals, and street signs.

As shown in FIG. 5, the dynamic image 20 includes a first region 50 containing information relating to navigation such as a graphic representation of the next turn in following a route, and a distance to that turn. The dynamic image 20 also includes a second region 52 additional containing information relating to navigation such as the name of the street or highway of the next turn to aid a driver in determining the actions to take to navigate the vehicle 12 to a destination.

As shown in FIGS. 4 and 5, the map image 44 includes overlaid graphics of navigational directions 45, which are shown as arrows or pathways that are colored or illuminated to show a pathway to follow or directions for the vehicle to perform in order to navigate along a route to a predetermined destination location.

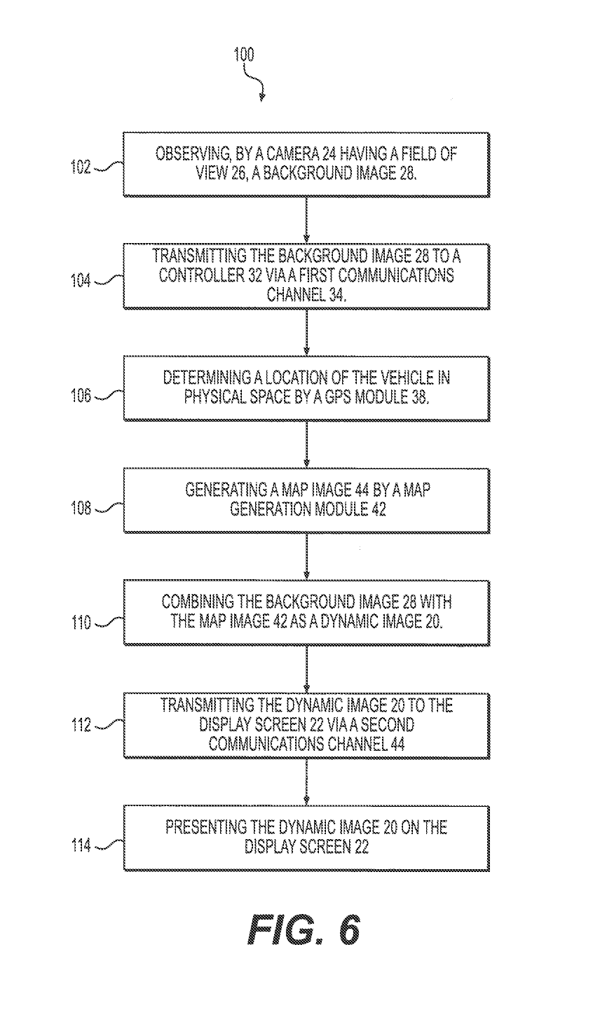

As illustrated in the flow chart of FIG. 6, a method 100 for generating a dynamic image 20 by a dynamic map display is also provided. The method 100 includes the steps of 102 observing, by a camera 24 having a field of view 26, a background image 28.

The method 100 also includes 104 transmitting the background image 28 to a controller 32 via a first communications channel 34. The background image 28 may be transmitted as a digital or analog channel, and the first communications channel 34 may be wired or wireless. The background image 28 may be updated rapidly, such as by being a video signal. The background image 28 may alternatively be updated only sporadically, such as in response to a major change. Reducing the frequency of updating the background image 28 may be useful, for example, to prevent driver distraction due to the background image 28 being rapidly switched, and may prevent unsafe behaviors such as a driver's use of the background image 28 for driving.

The method 100 also includes 106 determining a location of the vehicle in physical space by a GPS receiver 40. This step 106 may be accomplished by a combination of hardware, such as a GPS receiver or other radio receiver, and one or more software modules, which may run on the processor 36 of the controller 32.

The method 100 also includes 108 generating a map image 44 by a map generator 42. Examples of map images 44 are shown in FIGS. 3-5. The map image 44 may include navigational directions 45, which may take the form of, for example, arrows or pathways that are colored or illuminated to show a pathway through the map and/or turns or other maneuvers for the driver to perform to follow the recommended directions to navigate to a predetermined destination location.

The method 100 also includes 110 combining the background image 28 with the map image 44 as a dynamic image 20. This step 110 is preferably performed by an image generator 46 of the controller 32, which is illustrated in FIG. 2.

The method 100 also includes 112 transmitting the dynamic image 20 to the display screen 22 via a second communications channel 48. The dynamic image 20 may be transmitted as a digital or analog channel, and the second communications channel 48 may be wired or wireless.

The method 100 also includes 114 presenting the dynamic image 20 on the display screen 22. The display screen 22 may be a flat-screen display such as an LCD or OLED display. Alternatively, the step of 114 presenting the dynamic image 20 on the display screen 22 may involve projecting the dynamic image 20 on a projection surface or as a virtual image, for example, as a head-up display. The dynamic image 20 may be updated rapidly, such as by being a video signal. The dynamic image 20 may alternatively be updated occasionally or at irregular intervals, such as in response to a major change. For example, the dynamic image 20 may update only after the image becomes more than 10% brighter or 10% dimmer and/or not more often than once every 5 s or once per minute. Reducing the frequency of updates of the dynamic image 20 may be useful, for example, to prevent driver distraction due to the dynamic image 20 rapidly changing.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Obviously, many modifications and variations of the present invention are possible in light of the above teachings and may be practiced otherwise than as specifically described while within the scope of the appended claims.

1. A dynamic map display presenting a dynamic image on a display screen of a vehicle comprising:
a camera having a field of view and capturing a background image and transmitting the background image to a controller via a first communications channel;
the controller including a GPS receiver determining a location of the vehicle in physical space and a map generator generating a map image and an image generator combining the background image with the map image as the dynamic image;
a second communications channel to transmit the dynamic image from controller to the display screen, wherein the controller is configured to update the dynamic image at a predetermined frequency.

2. The dynamic map display as set forth in claim 1, wherein each of the background image and the map image are complementary shaped to fill the display screen.

3. The dynamic map display as set forth in claim 2, wherein each of the background image and the map image are rectangular.

4. The dynamic map display as set forth in claim 1, wherein the map image is formed as a tilted top view.

5. The dynamic map display as set forth in claim 1, wherein the map image has a perspective view from above and behind the vehicle.

6. The dynamic map display as set forth in claim 1, wherein the map image has a first-person view perspective.

7. The dynamic map display as set forth in claim 1, wherein the field of view is generally aimed above the horizon in front of the vehicle.

8. The dynamic map display as set forth in claim 1, wherein the controller includes a processor and a computer readable non-transitory memory.

9. The dynamic map display as set forth in claim 8, wherein the computer readable non-transitory memory stores instructions for execution by the processor to cause the processor to function as the GPS receiver.

10. The dynamic map display as set forth in claim 8, wherein the computer readable non-transitory memory stores instructions for execution by the processor to cause the processor to function as the map generator.

11. The dynamic map display as set forth in claim 8, wherein the computer readable non-transitory memory stores instructions for execution by the processor to cause the processor to function as the image generator.

12. A method for generating a dynamic image by a dynamic map display comprising:
observing a background image by a camera;
transmitting the background image to a controller via a first communications channel;
determining a location of a vehicle in physical space by a GPS receiver;
generating a map image by a map generator;
combining the background image with the map image as a dynamic image;
transmitting the dynamic image to the display screen via a second communications channel;
presenting the dynamic image on the display screen; and
updating the dynamic image at a predetermined frequency.

13. A non-transitory computer-readable medium encoded with instructions that, when executed in hardware, cause a processor at least to perform a process, the process comprising:
observing a background image by a camera;
transmitting the background image to a controller via a first communications channel;
determining a location of a vehicle in physical space by a GPS receiver;
generating a map image by a map generator;
combining the background image with the map image as a dynamic image;
transmitting the dynamic image to the display screen via a second communications channel;
presenting the dynamic image on the display screen; and
updating the dynamic image at a predetermined frequency.

14. The dynamic map display as set forth in claim 1, wherein the background image comprises a sky and other terrain or objects above a horizon.

15. The dynamic map display as set forth in claim 1, wherein regions above and beside a road are filled with the background image.

16. The dynamic map display as set forth in claim 1, wherein the map image is limited to only an area of road ahead and visible to the vehicle, while remaining area is filled with the background image.

17. The dynamic map display as set forth in claim 1, wherein the predetermined frequency includes a 5 second frequency.

18. The method as set forth in claim 12, wherein the predetermined frequency includes a 5 second frequency.

19. The non-transitory computer-readable medium as set forth in claim 13, wherein the predetermined frequency includes a 5 second frequency.

20. The non-transitory computer-readable medium as set forth in claim 13, wherein each of the background image and the map image are complementary shaped to fill the display screen.
